(19) United States
(12) Patent Application Publication
(10) Pub. No.: US 2011/0301793 A1
(43) Pub. Date: Dec. 8, 2011

(54) METHOD AND SYSTEM FOR CONTROLLING HYDRAULIC APPARATUS FOR CONTINUOUSLY VARIABLE TRANSMISSION OF HYBRID VEHICLE SYSTEM

(75) Inventors: KAI-CHING HSIEH, Taipei City (TW); Huan-Lung Gu, Hualien County (TW); Tseng-Te Wei, Hsinchu City (TW)

(73) Assignee: Industrial Technology Research Institute, Hsinchu (TW)

(21) Appl. No.: 12/950,555

(22) Filed: Nov. 19, 2010

(30) Foreign Application Priority Data
Jun. 8, 2010 (TW) 099118516

(51) Int. Cl. F16H 59/14

(52) U.S. Cl. 701/22; 180/65.275; 903/902

(57) ABSTRACT

The present invention provides a method and system for controlling hydraulic apparatus for CVT of a hybrid vehicle system, which adjust rotation speed of an input axial and output axial by means of hydraulic pressure generated from a first and a second hydraulic pump and guided through hydraulic circuits coupled to the input and output shafts for controlling gear ratio and output torque of the CVT. Meanwhile the present invention determines serial or parallel connection between the first and second hydraulic pumps according to the operation mode and status of the hybrid vehicle system so as to control the output of the CVT effectively. Besides, the present invention controls the hydraulic pressure of the first and second hydraulic pump for controlling the gear ratio of CVT such that the input source such as engine or motor can be operated in the optimized zone thereby reducing the energy consumption.

### TECHNICAL FIELD

The present disclosure relates to a continuously variable transmission (CVT) control method and system, and more particularly, to a method and system for controlling hydraulic apparatus for continuously variable transmission of hybrid vehicle systems.

### TECHNICAL BACKGROUND

In the early continuously variable transmission (CVT) design, there are centrifugal masses disposed inside the movable halve of it's active pulley while enabling the same to be activated in response to the rotation of engine, by that the belt radius pitch of the active pulley is changed accordingly and thus the rotation speed of its transmission shaft as well as the output torque are changed consequently. However, such CVT design is not capable of responding to all kinds of driving conditions fully and effectively that the engine using such CVT is not able to operate with optimum power output. In addition, as the aforesaid CVT is simple in structure, it is mostly used in motorscooters despite of its small torque output and unsatisfactory operation efficiency.

There must be million ways to accomplish a continuously variable gear ratio, and one recent design is a metal belt/variable pulley CVT, which is developed not only aiming for raising transmission torque, but also for increasing its transmission efficiency by more than 90%. Comparing with the conventional gear transmssion system, it is compact and light-weighted that is able to operate cooperatively with oil hydraulic circuits and valve system for achieving target gear ratio control. However, in order to generate sufficient clamping force and gear ratio so as to achieve high torque transmission in this metal belt/variable pulley CVT, a comparatively higher pressure as high as 30 Kg/cm² is required whereas such high pressure is usually being generated by the use of a hydraulic apparatus with patented oil hydraulic circuit design.

There are three methods already available for controlling the pressures with respect to the front and rear wheels. One of which is to achieve the pressure control by the designing of complicated oil hydraulic circuits and valve control mechanism for simplifying or alleviating the use and control of the hydraulic pump. The second is by the use of a plurality of adjustable hydraulic pumps for simplifying the oil hydraulic circuit design. The third is not only by the use of a plurality of adjustable hydraulic pumps, but also by designing a oil hydraulic circuit with pressure control mechanism. The aforesaid methods are disclosed in U.S. Pat. No. 6,547,694, U.S. Pat. No. 7,261,672, U.S. Pat. No. 6,287,227 and U.S. Pub. No. 2008/0039251. Especially in a conventional hydraulic continuous variable transmission system disclosed in U.S. Pat. No. 7,261,672, a two pump-driven hydraulic circuit and pressure control method are provided that can be adapted for hybrid vehicle systems. It is noted that by the design of its innovated serial-connecting oil circuits, its oil pressure is controlled by valve position control and motor control for achieving target gear ratio control.

### TECHNICAL SUMMARY

The present disclosure related to a method and system for controlling hydraulic apparatus for continuously variable transmission of hybrid vehicle system, in which a simple valve switch is used for controlling hydraulic pumps of a hydraulic apparatus to be serial connected or parallel connected, and thus the operation control of the hydraulic circuit connecting the hydraulic pumps is alleviated. Wherein, by the construction of the hydraulic circuit to be serial-connected, the pressure load of the corresponding hydraulic pumps can be reduced, in that hydraulic pressure generated from a first hydraulic pump that is simultaneously exerted upon two pulleys coupled respectively to an input shaft and an output shaft of a CVT system is used as a clamping force, while a second hydraulic pump that is serially connected with the first pump is used for boosting only the hydraulic pressure working upon the input shaft so that a pressure difference between the two pulleys is caused and used for determining a gear ratio for the CVT system. It is noted that the two hydraulic pumps are designed to function differently in this hydraulic circuit, i.e. one of the two is used for generating the clamping force, while the other is used for causing pressure difference to be used for determining a gear ratio for the CVT system, by that the hydraulic pressure control in the hydraulic circuit is comparatively more precise and accurate. On the other hand, by the construction of the hydraulic circuit to be parallel-connected, the hydraulic pressure generated from one of the two hydraulic pumps and a portion of hydraulic pressure generated from the other hydraulic pump are simultaneously used for causing the clamping force, while the pressure difference between the two hydraulic pumps is used for determining a gear ratio for the CVT system.

In addition, the present disclosure related to a method and system for controlling hydraulic apparatus for continuously variable transmission of a hybrid vehicle system, by that when a brake of the hybrid vehicle system is being stepped, the power transmission is reversed for causing the gear ratio to increase, and thereby, the connection of the hydraulic circuit that was originally in serial connection will be converted into parallel connection or in some condition that it will be changed into a reversed serial connection opposite to the original serial connection, and thus the rotation speed of the input shaft is increased so as to facilitate the power recovery operation of a power generator in the hybrid vehicle system during braking.

In an embodiment, the present disclosure provides a method for controlling hydraulic apparatus for continuously variable transmission of hybrid vehicle system, which comprises the steps of: providing a hybrid vehicle system, that is mounted on a vehicle having a control unit, and is comprised of: a first power source, a second power source, and a valve, for controlling the connection of a first hydraulic pump and a second hydraulic pump to be in serial connection or in parallel connection while enabling the first hydraulic pump and the second hydraulic pump to be coupled respectively to an output shaft and an input shaft; determining a lookup table relating to an operation process according to an operation mode of the hybrid vehicle system; determining a position for the valve during the performing of the operation process for controlling the connection of the first hydraulic pump and the second hydraulic pump to be in serial connection or in parallel connection; and determining an output torque according to the position of the valve while selecting and determining a gear ratio from the lookup table according to the speed of the vehicle and the position of the control unit; determining a first control signal and a second control signal respectively based upon the gear ratio and the output torque to be used for controlling the magnitude of the hydraulic pressures generated respectively from the first hydraulic pump and the second hydraulic pump.

In another embodiment, the present disclosure provides a system for controlling hydraulic apparatus for continuously variable transmission of hybrid vehicle system, which comprises: a hybrid vehicle system, being mounted on a vehicle having a control unit, and configured with a first power source, a second power source, and a valve, for controlling the connection of a first hydraulic pump and a second hydraulic pump to be in serial connection or in parallel connection while enabling the first hydraulic pump and the second hydraulic pump to be coupled respectively to an output shaft and an input shaft; a first controller, electrically connected to the control unit for enabling the same to receive a speed signal relating to the speed of the vehicle and an operation mode signal of the hybrid vehicle system so as to generate a first signal relating to an output torque based upon the position of the control unit and also generate a second signal based upon the speed of the vehicle and the position of the control unit to be used for determine a gear ratio from a lookup table; and a second controller, electrically connected to the first controller while being configured to receive the first signal and the second signal as well as a first hydraulic pressure signal relating to the first hydraulic pump so as to be as base for generating a first control signal for controlling the hydraulic pressure of the first hydraulic pump, a second signal for controlling the hydraulic pressure of the second hydraulic pump, and a valve control signal for controlling the position of the valve so as to determine the connection of the first hydraulic pump and the second hydraulic pump to be in serial connection or in parallel connection.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a system for controlling hydraulic apparatus for continuously variable transmission of hybrid vehicle system according to the present disclosure.

FIG. 2 is a schematic diagram showing the connection between a hydraulic apparatus and a CVT in the present disclosure.

FIG. 3A is a schematic diagram showing a control unit according to an exemplary embodiment of the present disclosure.

FIG. 3B is a schematic diagram showing a control unit according to another exemplary embodiment of the present disclosure.

FIG. 4 is a schematic diagram illustrating the relationship between engine speed and torque.

FIG. 5 is a schematic diagram illustrating the relationship between carrier speed, positioning of an actuating element, i.e. the throttle opening in this embodiment, and the gear ratio.

FIG. 6 is a flow chart depicting the steps performed in a method for controlling hydraulic apparatus for continuously variable transmission of hybrid vehicle system according to an embodiment of the present disclosure.

FIG. 7A is a flow chart depicting the steps performed in a process for determining the hydraulic circuit to be in serial connection or in parallel connection.

FIG. 7B is a schematic diagram showing the determination of the timing for switching between serial connection and parallel connection in the hydraulic circuit of the present disclosure.

FIG. 8 is a flow chart depicting the steps performed in a method for controlling hydraulic apparatus for continuously variable transmission of hybrid vehicle system according to another embodiment of the present disclosure.

FIG. 9A is a flow chart depicting the steps performed in a process for feedback controlling the gear ratio according to a first embodiment of the present disclosure.

FIG. 9B is a flow chart depicting the steps performed in a process for feedback controlling the gear ratio according to a second embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

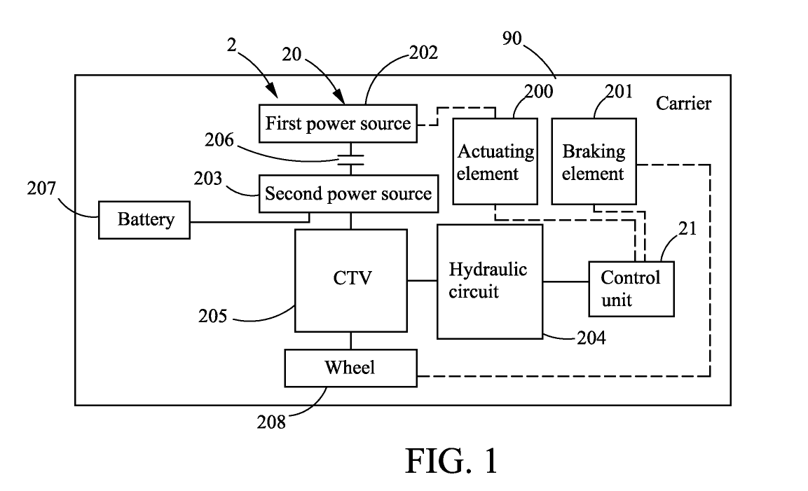

Please refer to FIG. 1, which is a schematic diagram showing a system for controlling hydraulic apparatus for continuously variable transmission of hybrid vehicle system according to the present disclosure. As shown in FIG. 1, the hydraulic apparatus control system 2 includes a hybrid vehicle system 20 that is further configured with two control units. In this embodiment, one of the two control units is an actuating element 200 and the other is a braking element 201 that are both being mounted on a carrier 90. It is noted that the carrier 90 can be a wheeled vehicle, but is not limited thereby that it can be any mobile device utilizing hybrid power. Moreover, the actuating element 200 can be a throttle and the braking element 201 can be a brake. In addition, the hybrid vehicle system 20 is further configured with a first power source 202, a second power source 203, a hydraulic circuit 204, a CVT 205 and a controller 21. As shown in FIG. 1, the first power source 202, being an engine in this embodiment, is coupled to the actuating element 200, i.e. a throttle, so that the rotation speed of the engine is controlled by the actuation percentage of the actuating element 200.

As the second power source 203 can be a motor that is powered by electricity, the hybrid vehicle system 20 that is designed to be driven by two different power sources, i.e. the engine 202 and the motor 203, is able to operate under different operation modes, which includes a motor-driven operation mode, a composite operation mode using both the motor and the engine, a power charging mode, an economy mode, and a dynamic mode. The first power source 202, referring as the engine hereinafter, is parallel coupled to the second power source 203, referring as the motor hereinafter, through a clutch 206, so that the two are able to operate and output power at the same time. In addition, the motor 203 can also function as a power generator that it can recycle the kinetic energy of the engine or the carrier and then convert the same into electricity so as to be saved in a battery 207. It is noted that the motor 203 is coupled to the CVT 205 at all time and the engine 202 can be sometimes be detached from the coupling with the clutch 206. Thus, when the engine is detached from the clutch 206, the hybrid vehicle system 20 is operating under the motor-driven operation mode, and when the engine is engaged with the clutch 206, the hybrid vehicle system 20 is operating under the composite operation mode using both the motor and the engine. Thus, operationally, the combined torque from the engine 202 and the motor 203 is transmitted to the wheel 208 through the CVT 205 for driving the carrier to move.

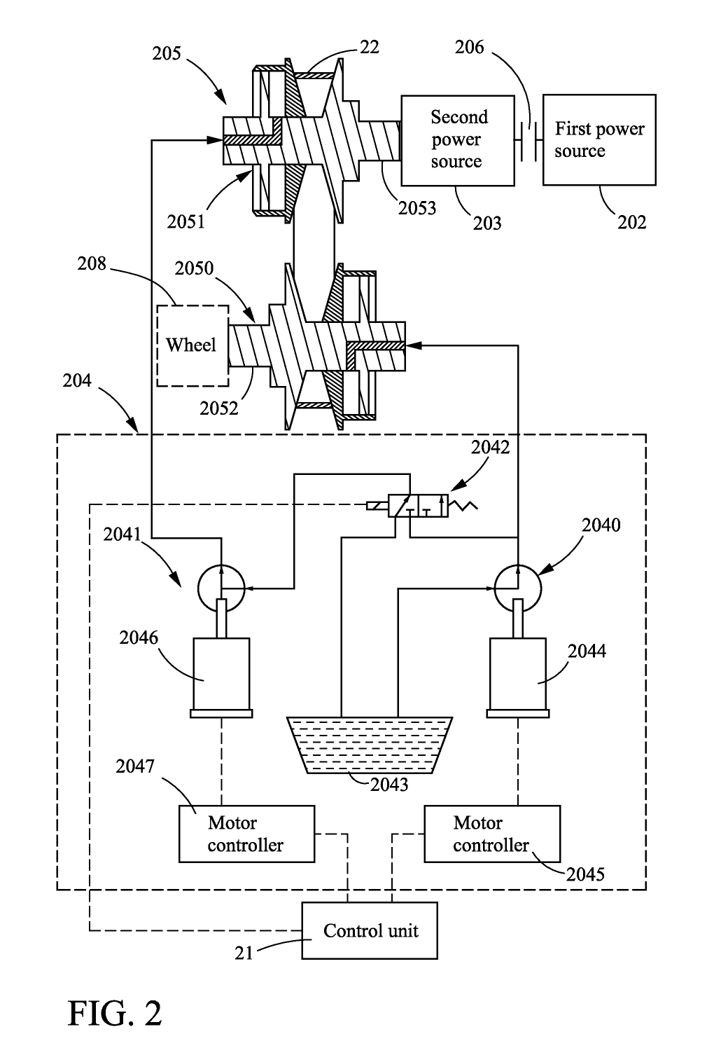

Please refer to FIG. 2, which is a schematic diagram showing the connection between a hydraulic apparatus and a CVT in the present disclosure. As shown in FIG. 2, the CVT 205 is connected to a hydraulic circuit 204. Moreover, the CVT 205 is composed of a first pulley 2050 and a second pulley 2051, in that the first pulley 2050 is coupled to the wheel 208 by the use of an output shaft 2052 and simultaneously coupled to the second pulley 2051 by a metal belt 22; while the second pulley 2051 is coupled with the second power source 203 by the use of an input shaft 2053. Thereby, the power from the first power source 202 and the second power source 203 can be transmitted to the second pulley 2051 through the input shaft 2053, where it is further being transmitted from the second pulley 2051 to the first pulley 2050 by the metal belt 22, and thereafter, the power is fed to the wheel 208 through the output shaft 2052 of the first pulley 2050 for driving the wheel 208 to rotate and thus bring along the carrier to move accordingly.

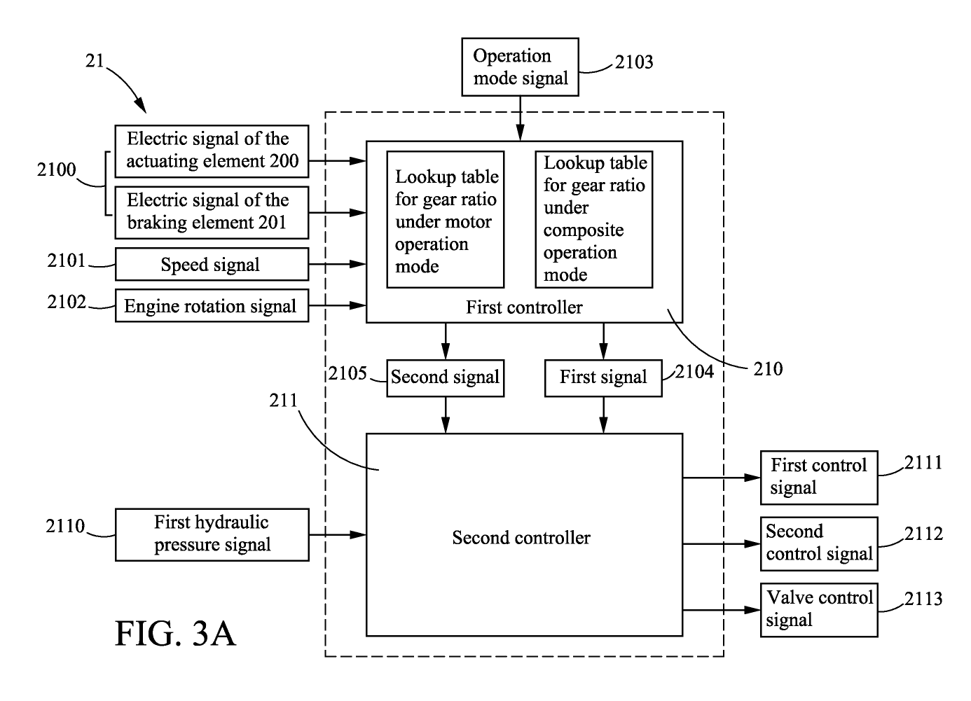

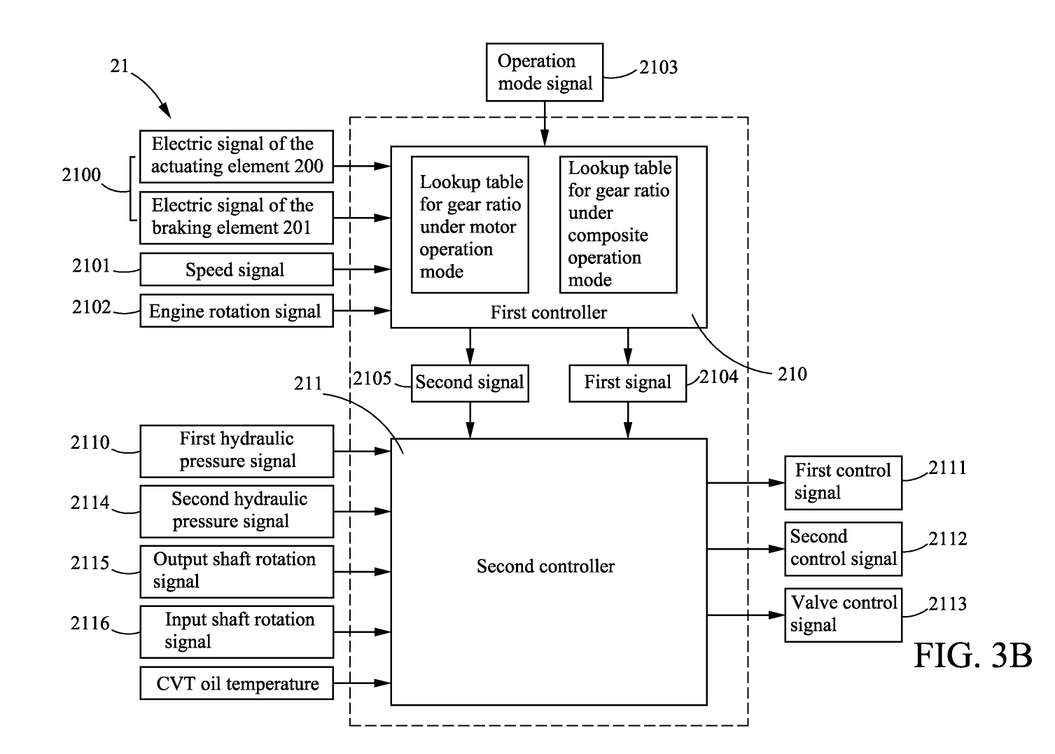

The hydraulic circuit 204 is configured with a first hydraulic pump 2040 and a second hydraulic pump 2041 in a manner that the first hydraulic pump 2040 is connected with the second hydraulic pump through a piping, a valve 2042 and a tank 2043. Moreover, the first hydraulic pump 2040 is comprised of a motor 2044 and a motor controller 2045, while similarly the second hydraulic pump 2041 is comprised of a motor 2046 and a motor controller 2047. As shown in FIG. 3, the valve 2042 is coupled to the first pulley 2050 and the second pulley 2051, which can be a 3-port2-position solenoid valve, but is not limited thereby. By controlling the position of the valve 2042, the first hydraulic pump 2040 can connect with the second hydraulic pump 2041 either in serial connection or in parallel connection. When in serial connection, in addition to be used for driving the first pulley 2050, the hydraulic pressure of the first hydraulic pump 2040 is also being used as the initial pressure of the second hydraulic pump 2041. In this embodiment, the liquid flowing inside the hydraulic circuit 204 is a type of oil, but is not limited thereby. Thus, when the two hydraulic pumps 2040, 2041 are brought along to fucntion for generating hydraulic pressures to be used for causing the two pulleys 2050, 2051 to perform an axial movement, the distances D between the two cones of the pulleys 12, 14 will be varied according to the pressure difference between the two pulleys 2050, 2051 so that the pitch radius of the belt 22 will be caused to change and thus determines a gear ratio accordingly. It is noted that the first and the second hydraulic pumps 2040, 2041 are driven respectively by the two motors 2044, 2046, and the two motors 2044, 2046 are control by their respective motor controllers 2045, 2047 while the two motor controllers 2045, 2047 are configured to receive their respective control signals from the control unit 21.

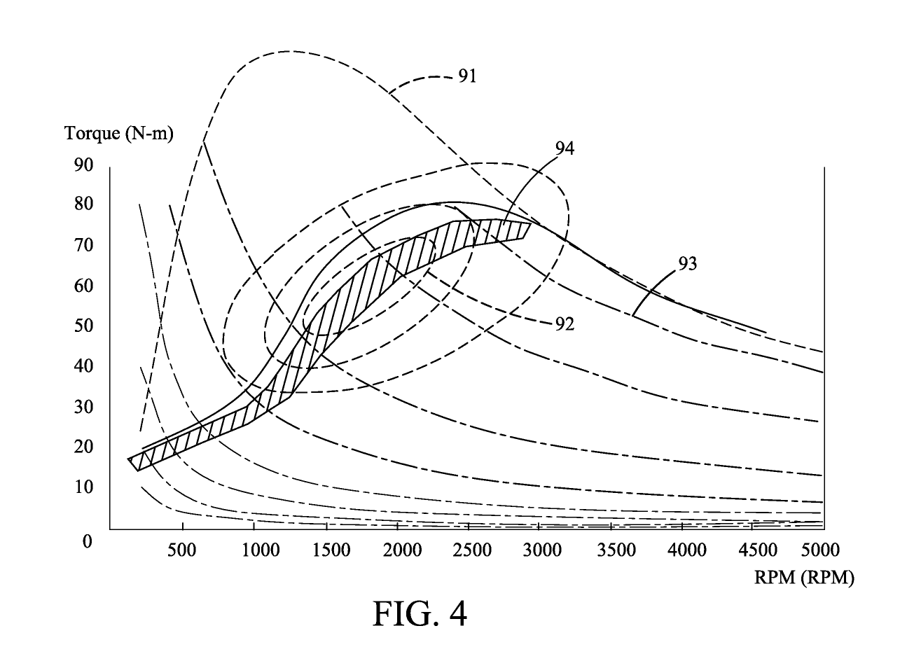

Please refer to FIG. 3A, which is a schematic diagram showing a control unit according to an exemplary embodiment of the present disclosure. In this embodiment, the control unit 21 is further configured with a first controller 210 and a second controller 211, in which the first controller 210 is electrically connected to the actuating element 200, i.e. the throttle, and the braking element 201, i.e. the brake, for enabling the same to receive electric signals 2100 relating to the statuses of the actuating element 200 and the braking element 201 respectively from the actuating element 200 and the braking element 201. Moreover, the first controller 210 is configured to receive a speed signal of the carrier 2101, and engine rotation signal 2102 and a operation mode signal 2103 from the hybrid vehicle system, and also is designed to generate a first signal 2104 relating to an output torque based upon the position of the actuating element 200 or the braking element 201, and also generate a second signal 2105 based upon the speed signal 2101 and the electric signals 2100 relating to the statuses of the actuating element 200 and the braking element 201 so as to be used for determine a gear ratio from a lookup table. It is noted that the operation mode is selected from the group consisting of: a motor-driven operation mode, a composite operation mode using both the motor and the engine, a power charging mode, an economy mode, and a dynamic mode, and the magnitude of the output torque is determined according to the positions of the actuating element 200 and the braking element 201. In this embodiment, the magnitude of the output torque is determined according to the throttle opening or the clamping of the brake that is based upon a pre-established lookup table relating to the relationship between the output torque with the throttle opening and/or the clamping of the brake. Operationally, the first controller 210 will consult the lookup table based upon the electric signals 2100 received from the actuating element 200 and the braking element 201 so as to issue a control signal for generating an output torque. Please refer to FIG. 4, which is a schematic diagram illustrating the relationship between engine speed and torque. As each engine is designed and featuring with a specific performance curve 91 illustrating the relationship between engine speed and output torque, and the engine speed is controlled by the throttle opening, it is clear that the magnitude of the output torque can be obtained according to a signal relating to the throttle opening, which is also true for the brake.

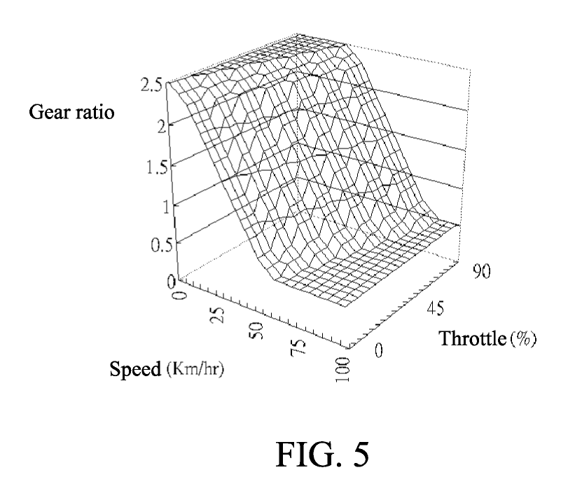

The lookup table relating to gear ratio can be a lookup table illustrating the gear ratio change under the motor-driven operation mode during an acceleration process (i.e. the stepping of the throttle), a lookup table illustrating the gear ratio change under the composite operation mode during an acceleration process, a lookup table illustrating the gear ratio change under the motor-driven operation mode during a deceleration process (i.e. braking), or a lookup table illustrating the gear ratio change under the composite operation mode during a deceleration process. Please refer to FIG. 5, which is a schematic diagram illustrating the relationship between carrier speed, positioning of an actuating element, i.e. the throttle opening in this embodiment, and the gear ratio. Different power sources will illustrate different performance and efficiency. Taking the engine performance curves shown in FIG. 4 for example, according to a concentration ellipse 92 that defines the efficiency, nodes relating to optimum efficiency can be detected on various constant-power curves 93, and thereby, an optimum operation zone 94 relating to the engine can be defined. In this optimum operation zone 94, the gear ratio is determined to be 1, and accordingly the gear ratios of other operation nodes can be determined following the constant-power curves 93. Thus, a relationship between gear ratio and optimum engine performance can be obtained, as the one shown in FIG. 5. It is possible to selected different lookup tables of different gear ratio relationships according to different operation modes or driving conditions, and such different lookup tables can be fine tuned according to the amount of power generated under economy mode, dynamic mode, or composite mode. That is, under the economy mode, the gear ratio will be decreased in advance when the speed is slowing down or the throttle is releasing; however, under the composite mode, since the engine is operating not only for bringing along the wheel to rotate, but also for generating electricity, the output torque of the engine will be increased for compensating the requirement of the power generation so that its performance curve will move toward the high efficiency area and thus the gear ratio will be increased for compensating.

As shown in FIG. 3A, the second controller 211 is electrically connected to the first controller 210 so as to receive the first signal 2104 and the second signal 2105 as well as a first hydraulic pressure signal 2110 relating to the first hydraulic pump 2040 so as to be as base for generating a first control signal 2111 for controlling the hydraulic pressure of the first hydraulic pump 2040, a second control signal 2112 for controlling the hydraulic pressure of the second hydraulic pump 2041, and a valve control signal 2113 for controlling the position of the valve 2042, as shown in FIG. 2, so as to determine the connection of the first hydraulic pump 2040 and the second hydraulic pump 2041 to be in serial connection or in parallel connection. Please refer to FIG. 3B, which is a schematic diagram showing a control unit according to another exemplary embodiment of the present disclosure. The embodiment shown in FIG. 3B is basically the same as the one shown in FIG. 3A, but is different in that: the embodiment of FIG. 3B is structured to be feedback controlled for maintaining the determined gear ratio and output torque respectively at a constant level. For enabling a feedback control process to be performed, the second controller 211 is configured for enabling the same to further receive a second hydraulic pressure signal 2114 relating to the second hydraulic pump 2041, rotation signals relating to the rotation speeds of the output shaft and the input shaft 2115, 2116. Thereby, the second controller 211 is able to determine the status of the output torque according to the first hydraulic pressure signal 2110, and adjust the first control signal 2111 for enabling the hydraulic pressure of the first hydraulic pump 2040 to equal to the hydraulic pressure of the first hydraulic pump 2040 that is defined by the first signal 2104. In addition, the second controller 211 is configured to perform a feedback control process according to a comparison between the gear ratio determined by the first controller 210 and the ratio of the rotation speeds of the output shaft and input shaft. Moreover, the second controller 211 can also be configured to perform a feedback control process according the comparison between the hydraulic pressure corresponding to the second hydraulic pressure signal 2114 and the hydraulic pressure of the second hydraulic pump 2041 that is determined based upon the gear ratio defined by the first controller 210, so as to be used as base for adjusting the second control signal for maintaining the gear ratio at a constant level.

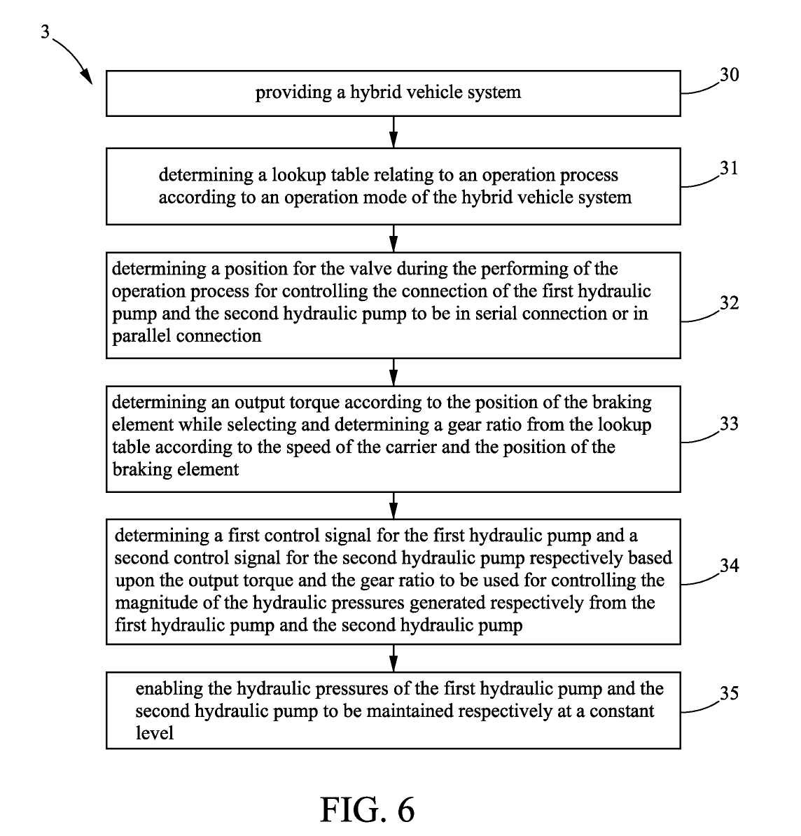

Please refer to FIG. 6, which is a flow chart depicting the steps performed in a method for controlling hydraulic apparatus for continuously variable transmission of hybrid vehicle system according to an embodiment of the present disclosure. The hydraulic apparatus control method 3 shown in FIG. 6 starts from the step 30. At step 30, a hybrid vehicle system, as the one shown in FIG. 1 and FIG. 2, is provided; and then the flow proceeds to step 31. It is noted that the structure as well as its hydraulic circuit is constructed the same as the aforesaid embodiment, and thus are not described further herein. At step 31, a lookup table relating to an operation process is determined according to an operation mode of the hybrid vehicle system; and then the flow proceeds to step 32. Similarly, the operation mode can be selected from the group consisting of a motor-driven operation mode, a composite operation mode using both the motor and the engine, a power charging mode, an economy mode, and a dynamic mode, whereas the operation process can be an acceleration process, i.e. the process when a throttle is being stepped, or a deceleration process, i.e. the process when a brake is being stepped or the throttle is being released. As the lookup table is determined according to the operation process and the operation mode that the hybrid vehicle system is subjected to, it is noted that for each operation mode, there will be different lookup tables corresponding respectively to either the acceleration or deceleration process, not to mention that different operation mode will result in different lookup tables. In this embodiment, the performing of the step 31 is illustrated as it is performed under the acceleration using the composite operation mode using both the motor and the engine, as the one shown in FIG. 3A, and thus, the lookup table to be determined is as the one shown in FIG. 5.

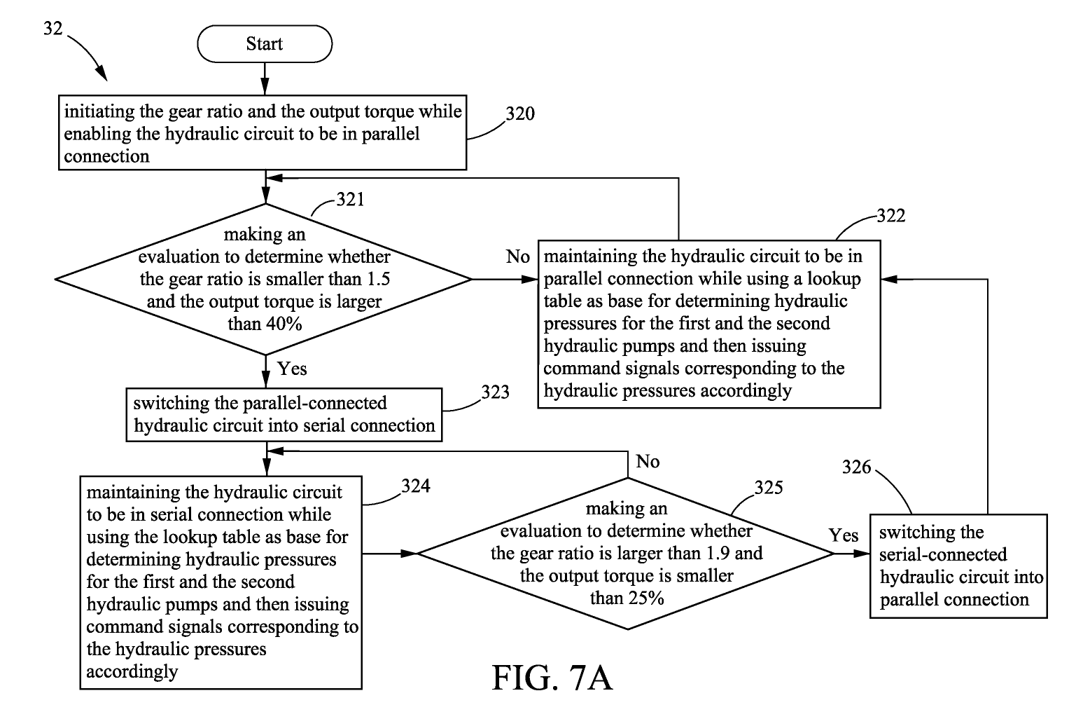

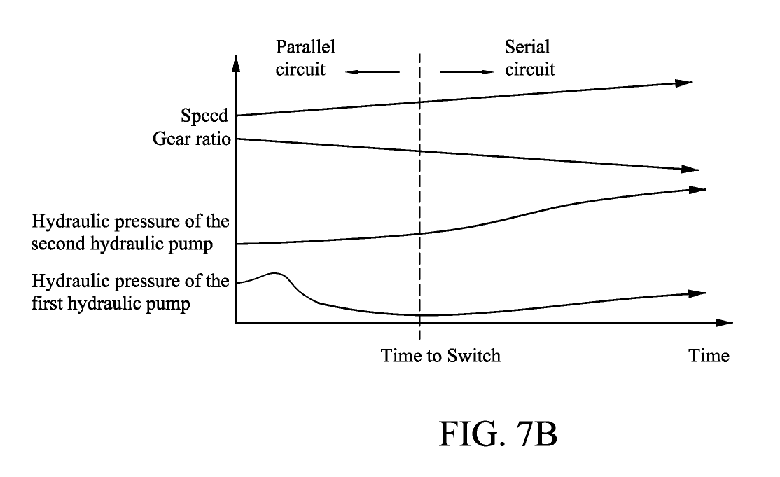

At step 32, a position for the valve is determined during the performing of the operation process for controlling the connection of the first hydraulic pump and the second hydraulic pump to be in serial connection or in parallel connection; and then the flow proceeds to step 33. It is noted that the valve position of step 32 is determined primarily according to the output torque and the gear ratio. Please refer to FIG. 7A, which is a flow chart depicting the steps performed in a process for determining the hydraulic circuit to be in serial connection or in parallel connection. The determination process 32 of FIG. 7A starts from the step 320. At step 320, the gear ratio and the output torque are initiated while enabling the hydraulic circuit to be in parallel connection at first; and then the flow proceeds to step 321. In this embodiment, the gear ratio is set to be 1.5 and the output torque is set to be 20% during the initiation, whereas the output torque is represented using the throttle opening ratio. At step 321, an evaluation is made to determine whether the gear ratio is smaller than 1.5 and the output torque is larger than 40%; if so, the flow proceeds to step 323 for switching the parallel-connected hydraulic circuit into serial connection and then directing the flow to process to step 324; otherwise, the flow proceeds to step 322. At step 322, the hydraulic circuit is maintained to be in parallel connection while using a lookup table as base for determining hydraulic pressures of the first and the second hydraulic pumps and then issuing command signals corresponding to the hydraulic pressures accordingly through a low-pass filter; and then the flow proceeds back to step 321. On the other hand, at step 324, after being switch into serial connection, the hydraulic circuit will maintain to be in serial connection while using the lookup table as base for determining hydraulic pressures for the first and the second hydraulic pumps and then issuing command signals corresponding to the hydraulic pressures accordingly through the low-pass filter; and then the flow proceeds to step 325. At step 325, another evaluation is made to determine whether the gear ratio is larger than 1.9 and the output torque is smaller than 25%; if so, the flow proceeds to step 326 for switching the serial-connected hydraulic circuit into parallel connection and then directing the flow to process to step 322; otherwise, the flow proceeds to 324. It is noted that the values of the gear ratio and the output torque used in the step 321 and the step 325 are determined according to actual requirement, and thus are not limited thereby but generally the prior threshold values should be larger than the posterior threshold values using in the method. Moreover, the step 31 and the step 32 may not have to be performed sequentially as the embodiment shown in FIG. 7A since the calculation of the processor used for these evaluation can be very fast that the ordering of the step 31 and the step 32 relating to which one is going to be performed prior to another will not cause any difference.

Back to FIG. 6, after the valve position is determined for controlling the connection of the first hydraulic pump and the second hydraulic pump to be in serial connection or in parallel connection, the flow will proceed to step 33. At step 33, an output torque is determined according to the position of the braking element while selecting and determining a gear ratio from the lookup table according to the speed of the carrier and the position of the braking element; and then the flow proceeds to step 34. In this embodiment, as the actuating element is designed to be a throttle that its opening can be detected by the use of a sensor and also the sensor can being used for detecting the speed of the vehicle, a lookup table can be determined according to the throttle opening and the vehicle speed using a first controller 210, not to mention that the output torque can also be acquired according to the throttle opening. Thereafter, at step 34, a first control signal for the first hydraulic pump and a second control signal for the second hydraulic pump are determined respectively based upon the output torque and the gear ratio to be used for controlling the magnitude of the hydraulic pressures generated respectively from the first hydraulic pump and the second hydraulic pump; and then the flow proceeds to step 35. It is noted that the output torque resulting from the performing of the step 33 is used for determining a hydraulic pressure for the first hydraulic pump as it is used for controlling a second controller 211 to generate a first control signal corresponding to the determined hydraulic pressure of the first hydraulic pump. Moreover, the second control signal is obtained either from a lookup table embedded in the second controller 211, or according to a specific formula, and it is going to be adjusted considering the serial/parallel connection of the hydraulic circuit.

Finally, at step 35, a control process is used for enabling the hydraulic pressures of the first hydraulic pump and the second hydraulic pump to be maintained respectively at a constant level. Moreover, the control process further comprises the steps of: (1) during parallel connection, adding the two hydraulic pressures of the first hydraulic pump from a lookup table and then comparing the added value with the actual hydraulic pressure of the first hydraulic pump for determining whether the hydraulic pressure of the first hydraulic pump is larger than the added value; if so, adjusting the first control signal for decreasing the hydraulic pressure of the first hydraulic pump; otherwise, increasing the first control signal; and thus causing the hydraulic pressure of the first hydraulic pump to be maintained at a constant level; and simultaneously, enabling the hydraulic pressure of the second hydraulic pump to be control solely based upon the hydraulic pressure of the second hydraulic pump from the lookup table, and if the hydraulic pressure of the second hydraulic pump is larger than the actual hydraulic pressure of the second hydraulic pump, enabling the second control signal to be decreased for reducing the hydraulic pressure of the second hydraulic pump; otherwise, enabling the second control signal to be increased; and thus causing the hydraulic pressure of the second hydraulic pump to be maintained at a constant level; and (2) during serial connection, measuring the hydraulic pressures of the first and the second hydraulic pumps, and then using a hydraulic pressure of the first hydraulic pump from the lookup table that is related to the output torque and the measured hydraulic pressure of the first hydraulic pump as base for adjusting the first control signal so as to maintain the hydraulic pressure of the first pump at a constant level; while using a hydraulic pressure of the second hydraulic pump from the lookup table that is related to the gear ratio and the measured hydraulic pressure of the second hydraulic pump as base for controlling the hydraulic pressure of the second pump to be maintained at a constant level.

Please refer to FIG. 7B, which is a schematic diagram showing the determination of the timing for switching between serial connection and parallel connection in the hydraulic circuit of the present disclosure. Taking the standing start acceleration process of a vehicle for example, when the vehicle is traveling at speed slower than its starting speed, the hydraulic circuit is enabled to be parallel connected for maximizing the pressure exerted upon the first hydraulic pump 2040 so as to maximizing the reduction in gear ratio and thus enable the second power source 203, i.e. the motor, to be provided with a sufficient high torque for the starting; when the vehicle speed is increasing gradually, the gear ratio is reduced with respected to the aforesaid different lookup tables, and accordingly the hydraulic pressure of the first hydraulic pump 2040 is reducing while the hydraulic pressure of the second hydraulic pump 2041 is increasing; and when the gear ratio is smaller than a threshold value, the parallel connection is switched into serial connection, so that the impact to the hydraulic pressures in the hydraulic circuit is minimized. Moreover, as in serial connection when the first hydraulic pump 2040 is used for providing the clamping force and the second hydraulic pump 2041 is used for controlling the gear ratio, the gear ratio of the CVT is controlled to become smaller while there is still sufficient clamping force for outputting torque accordingly, and simultaneously the first power source 202 and the second power source 203 are combined gradually so as to change into the composite operation mode while enabling the gear ratio to be determined basing upon a lookup table relating to the composite operation mode.

The operation process described in FIG. 6 is an acceleration process. However, if the operation process is a deceleration process, the method can further include a step for converting power to be used for charging. The conversion/charging process performed during the deceleration process further comprises the steps of: at the time when the throttle is released and the brake is activated, enabling a first controller to select and enter a power charging mode, and also issue a first signal of a negative torque command to a second controller; enabling the first controller to issue a gear ratio command according to the output torque and the speed of the vehicle, and also issue a second signal to the second controller for controlling the gear ratio to increase gradually during the deceleration process, and thus enabling the rotation speed of the input shaft to increase so as to bring along the rotation speed of the second power source to increase as well and thus increasing power charging capacity; and finally enabling the second controller to obtain hydraulic pressures relating to the first and the second hydraulic pumps from a lookup table based upon the first signal and the second signal and also the condition that whether they are serial connected or parallel connected, and measuring respectively the hydraulic pressures of the first and the second hydraulic pumps, and adjusting the first control signal and the second control signal in respective.

The primary control of the aforesaid conversion/charging process is to adjust the second control signal for increasing the hydraulic pressure of the second hydraulic pump while adjusting the first control signal so as to decrease the hydraulic pressure of the first hydraulic pump, by that the rotation speed of the input shaft is increased and thus brought along the rotation speed of the motor to increase as well, and thus the charging capacity is increased. In addition, when the brake is being stepped under the composite operation mode, the power generation of the electricity generator can be enhanced not only at the condition that the power transmission should be reversed, but also the hydraulic pressure of the second hydraulic pump should be increased for reducing the performing radius of the second pulley. Therefore, the serial connection of the first hydraulic pump and the second hydraulic pump is not appropriate that instead of causing the second hydraulic pump to generate high hydraulic pressure, the performance radius of the first pulley is enabled to reduce gradually for causing the rotation speed of the input shaft that is coupled to the second power source to increase, that is, the hydraulic pressure of the second hydraulic pump is decreased while the hydraulic pressure of the first hydraulic pump is increased, so that the rotation of the second power source is accelerated and thus the charging capacity is increased.

Using the aforesaid serial/parallel connection architecture, the process for switching the hydraulic circuit between serial connection and parallel connection as well as the hydraulic pressure relating thereto comprises the steps of: gradually decreasing the hydraulic pressure of the second hydraulic pump to a low level while simultaneously enabling the hydraulic pressure of the first hydraulic pump to drop gradually but at an extend smaller than that of the second hydraulic pump, and thereby, enabling the gear ratio to increase; and switching from serial connection into parallel connection as soon as the increasing of the gear ratio reach a limit for enabling the hydraulic pressure of the second hydraulic pump to drop even smaller while enabling the hydraulic pressure of the first hydraulic pump to increase, and thereby, enabling the gear ratio to be increased further. During the increasing of the gear ratio, the vehicle speed will decrease as the result of the braking that initiates the conversion/charging process. Thus, when the throttle is being stepped for acceleration, the gear ratio that was increased to a high level due to the previous braking will be caused to decrease without any contradiction.

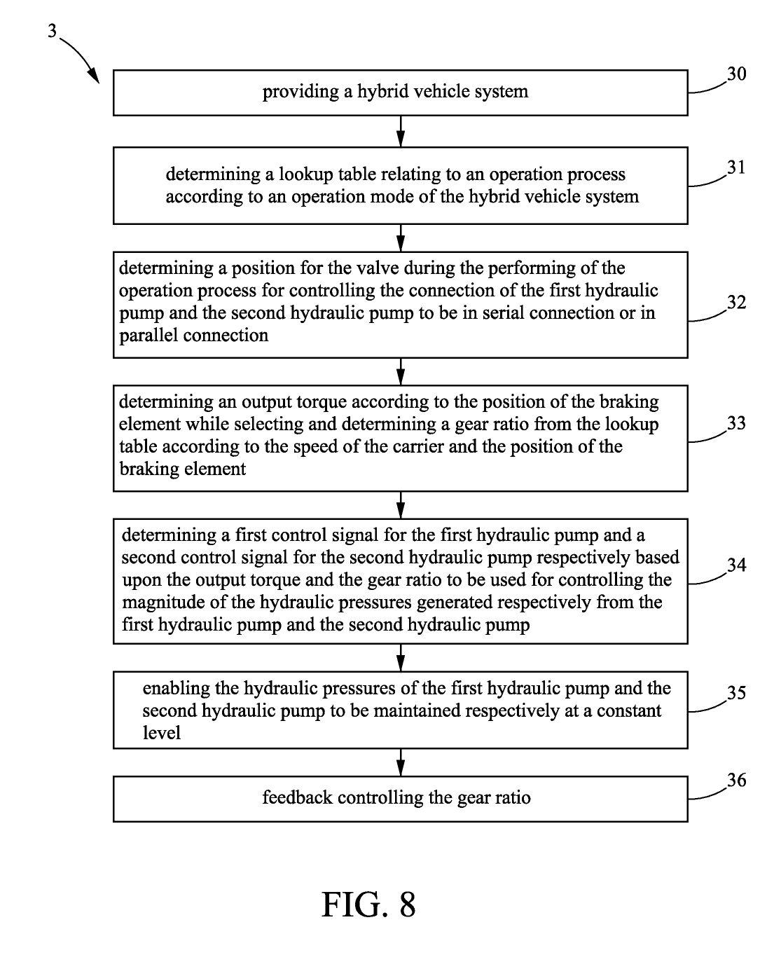

Please refer to FIG. 8, which is a flow chart depicting the steps performed in a method for controlling hydraulic apparatus for continuously variable transmission of hybrid vehicle system according to another embodiment of the present disclosure.

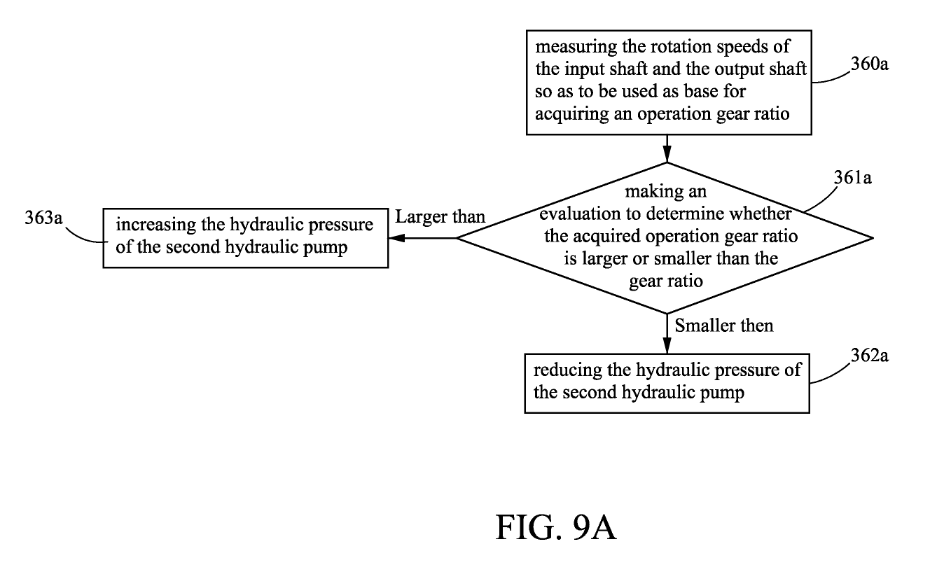

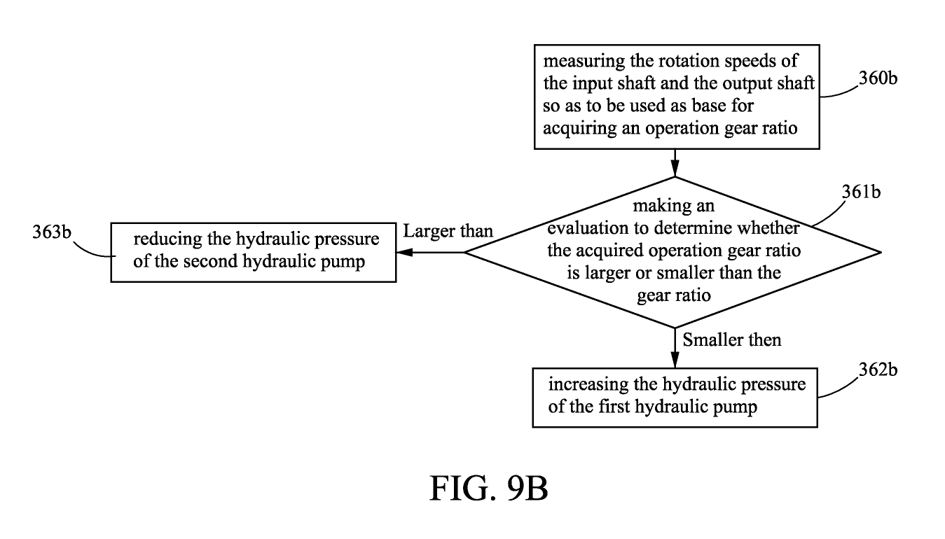

The method performed in this embodiment is basically the same as the one shown in FIG. 6, but is different in that: the method of the embodiment further comprises the step of: using a feedback control process for maintaining the gear ratio at a constant value, as the step 36 shown in FIG. 8. Please refer to FIG. 9A, which is a flow chart depicting the steps performed in a process for feedback controlling the gear ratio according to a first embodiment of the present disclosure. The steps shown in FIG. 9B illustrates the performing of the feedback control process when the valve is switched for enabling parallel connection. In FIG. 9A, the feedback control process will start from the step 360a. At step 360a, the rotation speeds of the input shaft and the output shaft are measured while diving one using another so as to obtain an operation gear ratio; and then the flow proceeds to step 361a. As shown in FIG. 3B, the second controller 211 is configured to receive rotation signals 2115, 2116 respectively from two rotation sensor coupled to the input shaft and the output shaft while feeding the received signals into a calculation for dividing the rotation speed of the input shaft by the rotation speed of the output shaft so as to obtained the operation gear ratio. At step 361a, an evaluation is made to determine whether the acquired operation gear ratio is larger or smaller than the gear ratio; if the gear ratio larger, then the flow proceeds to step 362a for enabling the hydraulic pressure of the second hydraulic pump to decrease; otherwise, the flow proceeds to step 363a for enabling the hydraulic pressure of the second hydraulic pump to increase; and thus enabling the operation gear ratio to be equal to the gear ratio.

Please refer to FIG. 9B, which is a flow chart depicting the steps performed in a process for feedback controlling the gear ratio according to a second embodiment of the present disclosure. The steps shown in FIG. 9B illustrates the performing of the feedback control process when the valve is switched for enabling parallel connection. In FIG. 9B, the feedback control process will start from the step 360b. At step 360b, the rotation speeds of the input shaft and the output shaft are measured while diving one using another so as to obtain an operation gear ratio; and then the flow proceeds to step 361b. At step 361b, an evaluation is made to determine whether the acquired operation gear ratio is larger or smaller than the gear ratio; if the gear ratio larger, then the flow proceeds to step 362b for enabling the hydraulic pressure of the first hydraulic pump to increase; otherwise, the flow proceeds to step 363b for enabling the hydraulic pressure of the second hydraulic pump to decrease; and thus enabling the operation gear ratio to be equal to the gear ratio.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for controlling hydraulic apparatus for continuously variable transmission of hybrid vehicle system, comprising the steps of:
providing a hybrid vehicle system, being mounted on a vehicle having a control unit, and comprised of: a first power source, a second power source, and a valve, for controlling the connection of a first hydraulic pump and a second hydraulic pump to be in serial connection or in parallel connection while enabling the first hydraulic pump and the second hydraulic pump to be coupled respectively to an output shaft and an input shaft;
determining a lookup table relating to an operation process according to an operation mode of the hybrid vehicle system;
determining a position for the valve during the performing of the operation process for controlling the connection of the first hydraulic pump and the second hydraulic pump to be in serial connection or in parallel connection;
determining an output torque according to the position of the valve while selecting and determining a gear ratio from the lookup table according to the speed of the vehicle and the position of the control unit; and
determining a first control signal and a second control signal respectively based upon the gear ratio and the output torque to be used for controlling the magnitude of the hydraulic pressures generated respectively from the first hydraulic pump and the second hydraulic pump.

2. The method of claim 1, wherein the operation mode is selected from the group consisting of: a solo operation mode relating to the second power source, a composite operation mode relating to the first and the second power sources, a power charging mode, an economy mode, and a dynamic mode.

3. The method of claim 1, wherein the control unit is further comprised of: a braking element and an actuating element, in that the braking element is a brake and the actuating element is a throttle.

4. The method of claim 3, wherein the operation process is selected from the group consisting of: an acceleration process and a deceleration process; the acceleration process is defined to be the period when the throttle is being activated, and the deceleration process is defined to be the period when the throttle is released and the brake is being activated.

5. The method of claim 4, wherein during the performing of any one of the acceleration process and the deceleration process, the position of the valve that is used as base for controlling the connection of the first hydraulic pump and the second hydraulic pump to be in serial connection or in parallel connection, is determined based upon the gear ratio and the output torque.

6. The method of claim 1, further comprising the step of:
using a control process for enabling the hydraulic pressures of the first hydraulic pump and the second hydraulic pump to be maintained respectively at a certain level.

7. The method of claim 6, wherein the control process comprises the steps of:
during parallel connection, adding the two hydraulic pressures of the first hydraulic pump from a lookup table that are related respectively to the output torque and the gear ratio and then comparing the added value with the hydraulic pressure of the first hydraulic pump for determining whether the hydraulic pressure of the first hydraulic pump is larger than the added value; if so, decreasing the first control signal; otherwise, increasing the first control signal; and thus causing the hydraulic pressure of the first hydraulic pump to be maintained at a certain level; and simultaneously, enabling the hydraulic pressure of the second hydraulic pump to be control solely based upon the hydraulic pressure of the second hydraulic pump from the lookup table that is related to the output torque in a manner that if the hydraulic pressure of the second hydraulic pump is larger than that corresponding to the output torque, enabling the second control signal to be decreased; otherwise, enabling the second control signal to be increased; and thus causing the hydraulic pressure of the second hydraulic pump to be maintained at a certain level; and
during serial connection, measuring the hydraulic pressures of the first and the second hydraulic pumps, and then using a hydraulic pressure of the first hydraulic pump from the lookup table that is related to the output torque and the measured hydraulic pressure of the first hydraulic pump as base for adjusting the first control signal so as to maintain the hydraulic pressure of the first pump at a constant level; while using a hydraulic pressure of the second hydraulic pump from the lookup table that is related to the gear ratio and the measured hydraulic pressure of the second hydraulic pump as base for controlling the hydraulic pressure of the second pump.

8. The method of claim 1, further comprising the step of:
using a feedback control process for maintaining the gear ratio at a certain value.

9. The method of claim 8, wherein during parallel connection the feedback control process further comprises the steps of:
measuring the rotation speeds of the input shaft and the output shafts so as to obtain an operation gear ratio by one with the other; and
comparing the operation gear ratio with the gear ratio, and if the gear ratio is larger than the operation gear ratio, the hydraulic pressure of the first hydraulic pump is increased; otherwise, the hydraulic pressure of the second hydraulic pump is decreased; and thus causing the operation gear ratio to be equal to the gear ratio.

10. The method of claim 8, wherein during serial connection, the feedback control process further comprises the steps of:
measuring the rotation speeds of the input shaft and the output shafts so as to obtain an operation gear ratio by one with the other; and
comparing the operation gear ratio with the gear ratio, and if the gear ratio is larger than the operation gear ratio, the hydraulic pressure of the second hydraulic pump is decreased; otherwise, the hydraulic pressure of the second hydraulic pump is increased; and thus causing the operation gear ratio to be equal to the gear ratio.

11. The method of claim 5, wherein the determining of the position for the valve for controlling the connection of the first hydraulic pump and the second hydraulic pump to be in serial connection or in parallel connection further comprising the steps of:
making an evaluation to determine whether the gear ratio is smaller than a first value and the output torque is larger than a second value;
if so, switching to serial connection; otherwise, switching to parallel serial connection; and
during serial connection, making an evaluation to determine whether the gear ratio is larger than a third value and the output torque is smaller than a fourth value; if so, maintaining the parallel connection; otherwise, switching to serial connection.

12. The method of claim 4, wherein during the deceleration process, an power conversion/charging process is being performed, and the power conversion/charging process further comprises the steps of:
at the time when the throttle is released and the brake is activated, enabling a first controller to select and enter a power charging mode, and also issue a first signal of a negative torque command to a second controller;
enabling the first controller to issue a gear ratio command according to the output torque and the speed of the vehicle, and also issue a second signal to the second controller for controlling the gear ratio to increase gradually during the deceleration process, and thus enabling the rotation speed of the input shaft to increase so as to bring along the rotation speed of the second power source to increase as well and thus increasing power charging capacity; and
enabling the second controller to obtain hydraulic pressures relating to the first and the second hydraulic pumps from a lookup table based upon the first signal and the second signal and also the condition that whether they are serial connected or parallel connected, and measuring respectively the hydraulic pressures of the first and the second hydraulic pumps, and adjusting the first control signal and the second control signal in respective.

13. A system for controlling hydraulic apparatus for continuously variable transmission of hybrid vehicle system, comprising:
a hybrid vehicle system, being mounted on a vehicle having a control unit, and configured with a first power source, a second power source, and a valve, for controlling the connection of a first hydraulic pump and a second hydraulic pump to be in serial connection or in parallel connection while enabling the first hydraulic pump and the second hydraulic pump to be coupled respectively to an output shaft and an input shaft;
a first controller, electrically connected to the control unit for enabling the same to receive a speed signal relating to the speed of the vehicle and an operation mode signal of the hybrid vehicle system that is related to an operation mode so as to generate a first signal relating to an output torque based upon the position of the control unit and also generate a second signal based upon the speed of the vehicle and the position of the control unit to be used for determine a gear ratio from a lookup table; and
a second controller, electrically connected to the first controller while being configured to receive the first signal and the second control signal as well as a first hydraulic pressure signal relating to the first hydraulic pump so as to be as base for generating a first control signal for controlling the hydraulic pressure of the first hydraulic pump, a second signal for controlling the hydraulic pressure of the second hydraulic pump, and a valve control signal for controlling the position of the valve so as to determine the connection of the first hydraulic pump and the second hydraulic pump to be in serial connection or in parallel connection.

14. The system of claim 13, wherein the second controller is configured to receive a second hydraulic pressure signal relating to the second hydraulic pump, and rotation signals relating to the rotation speeds of the output shaft and input shaft.

15. The system of claim 14, wherein the second controller is configured to perform a feedback control process according to a comparison between the gear ratio and the ratio of the rotation speeds of the output shaft and input shaft.

16. The system of claim 13, wherein the control unit is a device selected from the group consisting of: a throttle and a brake.

17. The system of claim 13, wherein the operation mode is selected from the group consisting of: a solo operation mode relating to the second power source, a composite operation mode relating to the first and the second power sources, a power charging mode, an economy mode, and a dynamic mode.

18. The system of claim 13, wherein the first controller and the second controller can be integrated as one device.
